(19) United States
(12) Patent Application Publication
(10) Pub. No.: US 2003/0092424 A1
(43) Pub. Date: May 15, 2003

(54) Transmission method of wireless virtual channels

(76) Inventors: John Kuo, Taipei (TW); Mark Chao, Taipei (TW); Guo Cheng Shie, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/987,216

(22) Filed: Nov. 14, 2001

(51) Int. Cl. H04M 1/66

(52) U.S. Cl. 455/411; 455/410

(57) ABSTRACT

The present invention relates to a transmission method of wireless virtual channels and in particular to the data transmission between wireless host device and child devices. Both of the child device and the host device store a number of sets of family ID and security ID. The child device is the emitter and the host device is the receiver. The child device sends out a set of family ID and security ID by using at least one key or activation unit to the host device that receives and identifies the family ID and security ID. Insertion of the family ID and the security ID to each string of wireless data transmitted between the child device and the host device serves as the certification purpose so that one or multiple data transmission channels can be virtually created.

### BACKGROUND OF THE INVENTION

The present invention relates to a transmission method of wireless virtual channels, in particular to a method that construct communication channels for wireless data transmission.

Wireless transmission is a very popular method for digital data transmission on computers and electronic equipment, such as, signal and data transmission between a wireless keyboard, a wireless mouse, a wireless joystick and the computer, data transmission between two wireless USB devices, and control data and command transmission between the host and child device of a wireless controller. Conventional wireless transmission method for computers and electronic equipments is based on the circuit designs of the emitter and the receiver, which can produce wireless signals at the same frequency. If the transmission frequencies are set to be the same or tuned at a common channel, a computer and a single wireless keyboard can smoothly transmit data to each other. However, if more than one computer or more than one wireless keyboard are operated in the same area, data transmission may be mistakenly altered or exchanged due to interrupted channels or overlapped frequencies.

Therefore, for overcoming the above-mentioned drawback of miscommunication, some conventional computers are equipped with channel switches or circuit jumpers so that several channels, instead of one, can be selected from and thus chances of miscommunication can be reduced. In order to produce computers with such channel switches or circuit jumpers, the circuit design is inevitably complicated and the manufacturing cost is increased. Furthermore, for users in an interior space where multiple computers and wireless keyboards are used, great efforts must be placed on properly arrangement and distribution of limited channels. This conventional wireless transmission method between host and child devices by channel switches and circuit jumpers will be very troublesome to operate properly when the number of wireless devices in a same area is large. This situation might finally reach a limit and the operation cost will then be increased due to the need of purchase of new wireless transmission interfaces in computers and wireless keyboards.

### SUMMARY OF THE INVENTION

It is therefore an object of the present invention to provide a transmission method of virtual channels where the channel of wireless transmission can be defined freely in order to prevent the channel overlapping and interruption.

It is another object of the present invention to provide a transmission method of virtual channels in which the user can change the transmission channel without the need of changing the circuit or hardware of the transmission interface so that the manufacturing cost and the market price of the product can be significantly reduced.

It is a further object of the present invention to provide a transmission method of virtual channels with which users do not need to arrange, assign, memorize and switch channels so that the operation of the wireless equipments can be simplified.

It is a further object of the present invention to provide a transmission method of virtual channels where the number of transmission channels can be unlimitedly expanded and the transmission will not be degraded by the increased number of wireless devices.

For accomplishing the above object, the present invention provides a transmission method of virtual channels, which is characterized in that both the host device and the child device store a large number of family ID and security ID, in which the child device is the emitter, and the host device is the receiver. Once the child device emits one set of family ID and security ID by pressing at least one key or other activation unit, the host device will receive and identify such IDs and then define these IDs as the authorized identity for further wireless transmission. These agreed family and security IDs will be added into the top of data string created in each wireless transmission emitted either by the host or the child device so that the receiving device can check the identity of each data string and determine if such data string is meant for the checking device to receive. By this approach, one or multiple virtual channels of wireless transmission can be established.

Other objects, advantages and constructions of the present invention will become more apparent from the following description and the drawings.

### BRIEF DISCRIPTION OF THE DRAWINGS

The present invention will be apparent to those skilled in the art by reading the following description of preferred embodiments thereof, with reference to the accompanying drawings, in which:

FIG. 1 is a block diagram showing the hardware system of the present invention;

FIG. 2 is a flowchart showing the setting procedure of the family and security IDs for the host and child devices in the first embodiment;

FIG. 3 is a flowchart showing the setting procedure of family and security IDs for host and child devices in the second embodiment;

FIG. 4 is a flowchart showing the setting procedure of family and security IDs for the host and child devices in the third embodiment; and

FIG. 5 is a flowchart showing wireless two-way data transmission of the present invention.

### DETAILED DESCRIPTION OF THE PREFERRED EMBODIMENT

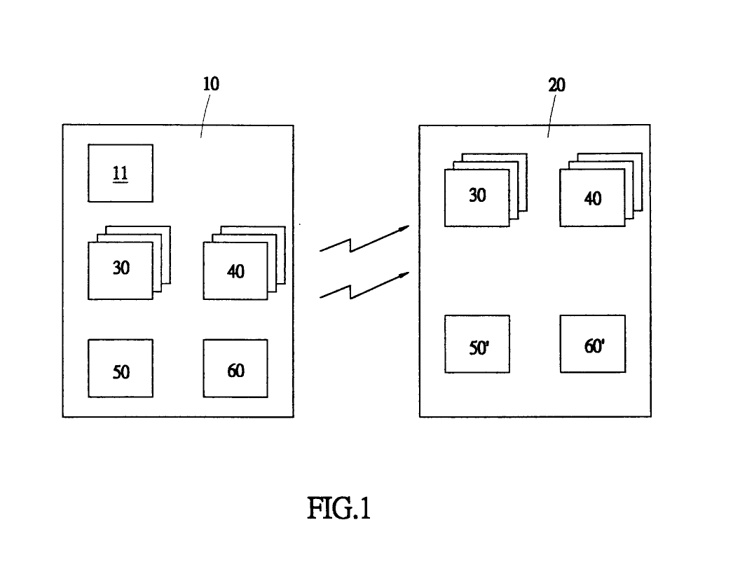

Referring to FIG. 1, the hardware system of the present invention comprises the child device 10 and the host device 20, which both are electronic equipments capable of conducting wireless data transmission. The child device 10 and the host device 20, such as the wireless keyboard and the host computer, both store a number of sets of family ID (FID) 30 and security ID (SID) 40. At least one key 50 or activation unit 60 is installed on the child device 10, and similarly at least one key 50′ or activation unit 60′ is installed on the host device 20 so that the child device 10 as the emitter and the host device 20 as the receiver can conduct wireless data transmission through the setting of both FID 30 and SID 40. The keys 50 and 50′ can be a number or character key and the activation units 60 and 60′ can be photo-sensor, touch, card-reading apparatuses, or any other device that can be used as an input unit.

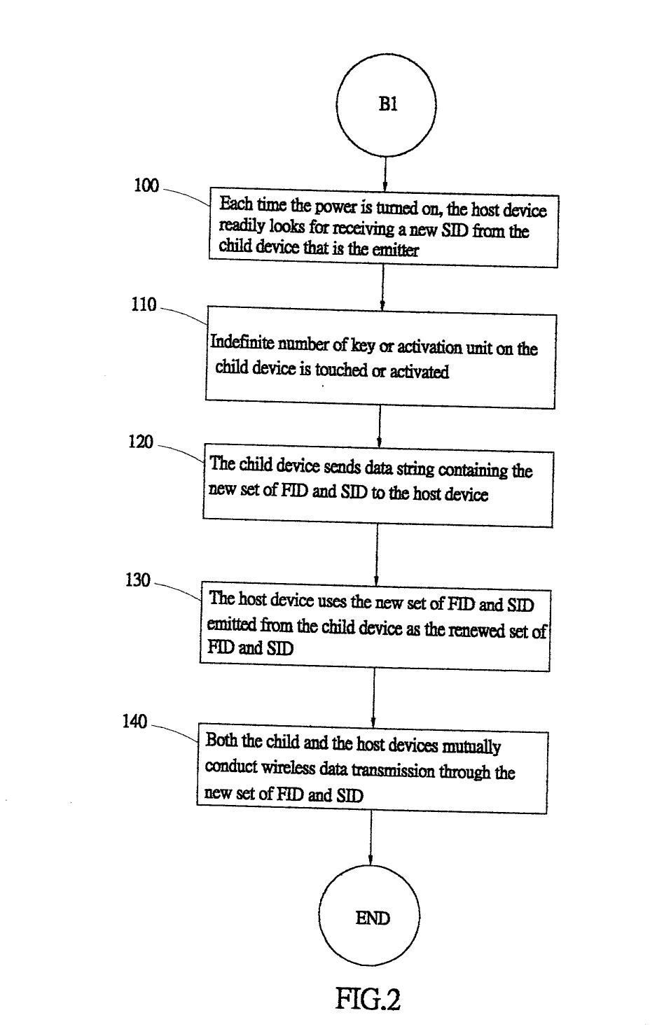

Referring to FIG. 2, the first embodiment of the present invention shows how the FID 30 and the SID 40 are implemented between the child device 10 and the host device 20 in which the child device 10 is the emitter and the host device 20 is the receiver. The procedure of implementation of the FID 30 and SID 40 between two devices is defined as follows:

(100) The host device 20 after being turned on its power is always in a ready status for receiving a new SID 40 from the child device 10 that is the emitter;

(110) During the FID 30 and SID 40 setting stage, at least one key 50 or activation unit 60 on the child device 10 is touched or activated so that a new set of FID 30 and SID 40 can be produced;

(120) The child device 10 sends data string containing the new set of FID 30 and SID 40 to the host device 20;

(130) The host device 20 uses the new set of FID 30 and SID 40 emitted from the child device 10 as the renewed set of FID 30 and SID 40; and

(140) Both the child device 10 and the host device 20 mutually conduct wireless data transmission through the new set of FID 30 and SID 40.

The first embodiment details the implementation of FID 30 and SID 40 between the child device 10 and the host device 20 in which the child device 10 is the one on which the implementation of transmission setting is mainly conducted. Such practice provides the users of personal computers and industrial computers advantages of active implementation of new settings and ease of operation

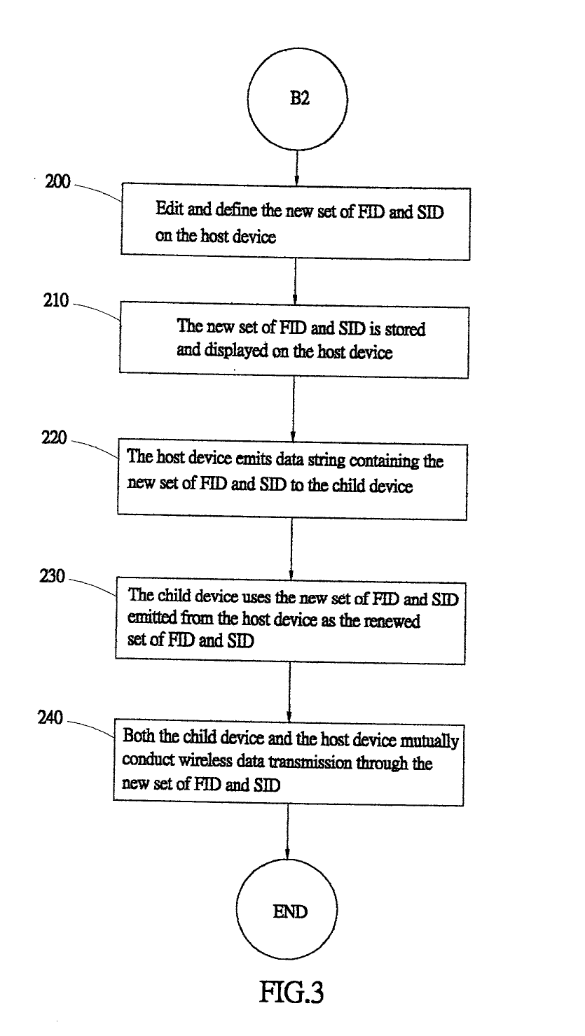

Referring to FIG. 3, the second embodiment of the present invention shows how the FID 30 and the SID 40 are implemented between the child device 10 and the host device 20 in which, contrary to the first embodiment, the host device 20 is now the emitter and the child device 10 is the receiver. The procedure of implementation of the FID 30 and SID 40 between two devices is defined as follows:

(200) Edit and define the new set of FID 30 and SID 40 on the host device 20;

(210) The new set of FID 30 and SID 40 will be stored and displayed on the host device 20;

(220) The host device 20 sends data string containing the new set of FID 30 and SID 40 to the child device 10;

(230) The child device 10 uses the new set of FID 30 and SID 40 emitted from the host device 20 as the renewed set of FID 30 and SID 40; and

(240) Both the child device 10 and the host device 20 mutually conduct wireless data transmission through the new set of FID 30 and SID 40.

The second embodiment uses the host device 20 as the device in which the setting of FID 30 and SID 40 is implemented. For example, if the computer and the wireless keyboard represents the host device 20 and the child device 10, respectively, the computer is installed with a software which is used for editing and defining the new set of FID 30 and SID 40 by the use of a number of compound keys, and the new set of FID 30 and SID 40 are then stored and displayed on the host device 20. The new set of FID 30 and SID 40 are then emitted to the child device 10 so as to initiate the wireless data transmission between the host device 20 and the child device 10 based on the common setting of FID 30 and SID 40.

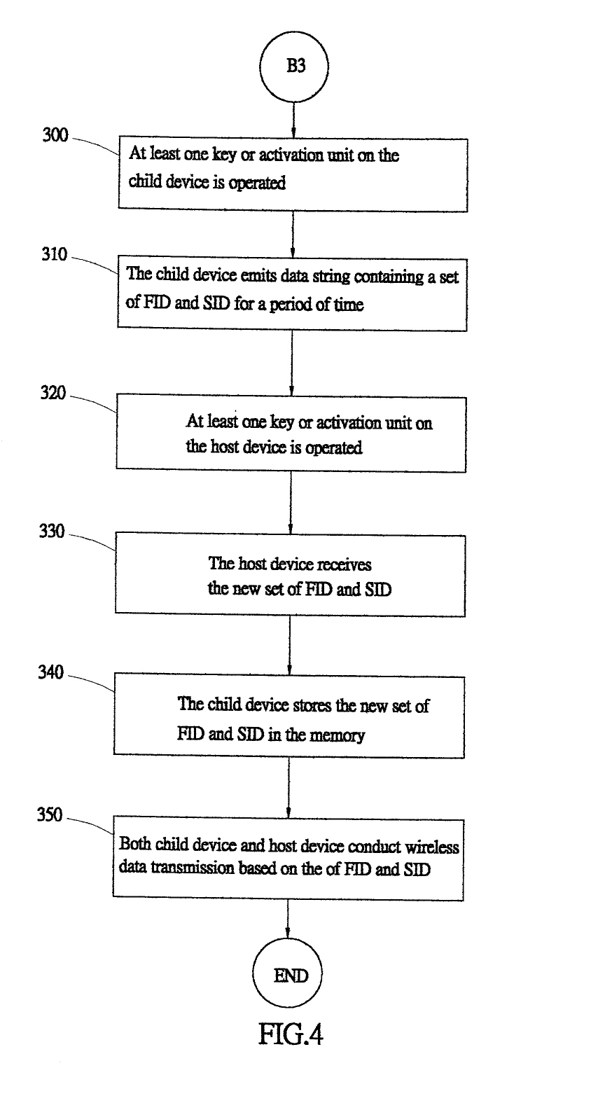

Referring to FIG. 4, the third embodiment of the present invention shows how the FID 30 and SID 40 are implemented between the child device 10 and the host device 20 in which, the child device 10 is the emitter and the host device 20 is the receiver between which a data transmission setting control mechanism is implemented and the child device 10 contains a memory 11. The procedure of implementation of the FID 30 and SID 40 between two devices is defined as follows:

(300) At least one key or activation unit on the child device 10 is operated;

(310) The child device 10 emits data string containing a set of FID 30 and SID 40 for a period of time;

(320) At least one key or activation unit on the host device 20 is operated;

(330) The host device 20 receives the new set of FID 30 and SID 40;

(340) The child device 10 stores the new set of FID 30 and SID 40 in the memory 11; and

(350) Both child device 10 and host device 20 conduct wireless data transmission based on the set of FID 30 and SID 40.

In the above-described embodiment, the key 50 or activation unit 60 of the child device 10, and the key 50′ or activation unit 60′ of the host device 20 are used to implement the certification when the FID 30 and SID 40 for data transmission are defined. The more precise certification of FID 30 and SID 40 between the host device 20 and the child device 10 as in the third embodiment can avoid transmission errors that often happen when more than one child device 10 attempt to conduct the certification of the FID 30 and SID 40 with the host device 20.

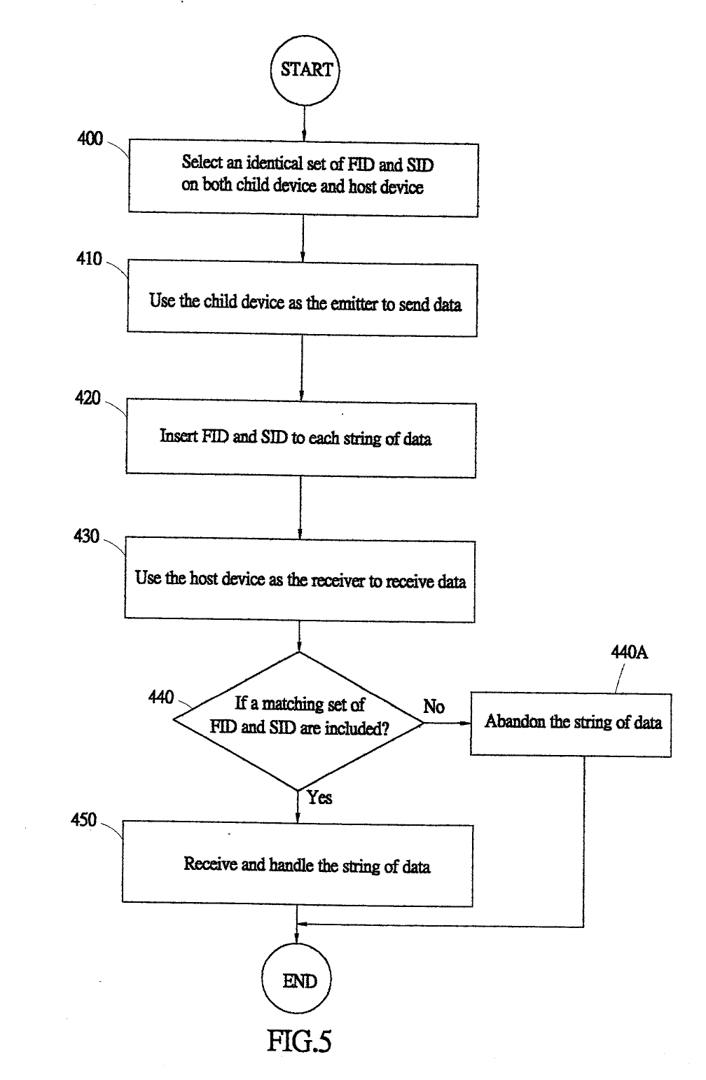

Referring to FIG. 5, the data transmission procedure of the present invention comprises the following steps:

(400) Select an identical set of FID 30 and SID 40 on both child device 10 and host device 20;

(410) Use the child device 10 as the emitter to send data;

(420) Insert FID 30 and SID 40 to each string of data;

(430) Use the host device 20 as the receiver to receive data;

(440) Detect each string of data if a matching set of FID 30 and SID 40 are included. If included, proceed to (450); if not included, proceed to (440A);

(450) Receive and handle the string of data; and

(440A) Abandon the string of data.

In the above data transmission procedure, the setting implementation of FID 30 and SID 40 between the child device 10 and the host device 20 can be achieved according to methods defined in either of the three embodiments as shown in FIGS. 2, 3, and 4. The insertion of FID 30 and SID 40 to each data string as in (420) of FIG. 5 can be implemented in a form of serial data strings or firmware.

Referring to FIGS. 1 to 5 which reveal the present invention, the touch implementation of a key 50 or activation unit 60 on the child device 10 and a key 50′ or activation unit 60′ on the host device 20 produces a number of FID 30 and SID 40 combinations that are used to virtually set an unlimited number of wireless transmission channels so that a multiple number of child devices 10 can conduct wireless data transmission with the host device 20 in the same region without the chance of losing data strings due to channel interference. Furthermore, without the need of changing circuit designs, the present invention enables users to easily select a wireless transmission channel represented by a set of FID 30 and SID 40 so that the cost of the product is reduced and the operation of the wireless transmission is made easier.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A transmission method of wireless virtual channels comprising a child device and a host device, both of the child device and the host device storing a number of sets of family ID and security ID, the child device being the emitter and the host device being the receiver, the child device sending a set of family ID and security ID by touching at least one activation unit to the host device which receives and identifies the family ID and security ID.

2. The transmission method of wireless virtual channels as claimed in claim 1, wherein the transmission process comprises the following steps:
(a) selecting the same set of family ID and security ID on both of the child device and the host device;
(b) using the child device as the emitter to send wireless data;
(c) inserting the family ID and the security ID to each string of wireless data;
(d) using the host device as the receiver to receive wireless data;
(e) detecting each string of wireless data if a matching set of family ID and security ID are included; and
(f) receiving and handling the string of wireless data.

3. The transmission method as claimed in claim 1, wherein the setting of the same set of family ID and security ID comprises the following steps:
(a) the host device after being turned on the power being ready to receive a new SID from the child device as the emitter;
(b) at least one activation unit on the child device being operated;
(c) the child device sending data string containing a predefined set of FID and SID to the host device;
(d) the host device using the set of FID and SID emitted from the child device as the renewed set of FID and SID; and
(e) both the child device and the host device conducting wireless data transmission through the set of FID and SID.

4. The transmission method as claimed in claim 1, wherein the child device contains a memory and the setting of the same set of family ID and security ID on both of the child device and the host device comprising the following steps:
(a) at least one activation unit on the child device being operated;
(b) the child device sending data string containing a set of FID and SID for a period of time;
(c) at least one activation unit on the host device being operated;
(d) the host device receiving the set of FID and SID;
(e) the child device storing the set of FID and SID in the memory; and
(f) both the child device and the host device conducting wireless data transmission through the set of FID and SID.
